(19) United States
(12) Patent Application Publication
(10) Pub. No.: US 2017/0311604 A1
(43) Pub. Date: Nov. 2, 2017

(54) A GALVANIC PROCESS, A CHROMED MATERIAL ADDITIVATED WITH SILVER NANOPARTICLES, AND USE OF AN ADDITIVATED MATERIAL

(71) Applicant: Docol Metais Sanitários Ltda., Joinville (BR)

(72) Inventor: Ingo Doubrawa, Joinville (BR)

(21) Appl. No.: 15/522,480

(22) PCT Filed: Jul. 8, 2015
(86) PCT No.: PCT/BR2015/050087

§ 371 Date: Apr. 27, 2017

(30) Foreign Application Priority Data
Oct. 29, 2014 (BR) BR102014027007-8

(51) Int. Cl. A01N 59/16; C25D 3/12; A01N 25/26; C25D 3/04; C25D 15/00; C25D 5/14

(52) U.S. Cl. CPC A01N 59/16; C25D 15/00; C25D 5/14; A01N 25/26; C25D 3/04; C25D 3/12

(57) ABSTRACT

The present invention relates to a galvanic process additivated with nanotechnology, wherein silver nanoparticles are added to the composition of a galvanic bath (10b), capable of forming a nickel layer (101), onto which a chrome layer (102) is deposited to form a material with antibacterial properties, which may be applied in manufacturing the most varied devices or materials.

### INTRODUCTION

The present invention relates to a device, material and process for galvanizing metals or plastics, which comprises adding silver nanoparticles in order to impart to the galvanized object antibacterial protection, besides keeping the properties of resistance to corrosion and to wear.

### PRIOR ART

The galvanic process is a chemical or electrolytic process of depositing a thin layer of a metal onto a surface, which may or may not be a metallic surface, for the purpose of embellishing the parts, increasing their durability by virtue of better surface properties, besides imparting corrosion resistance.

At present, there are a growing number of recently registered cases of hospital infections caused by bacteria. Such bacteria become more and more resistant to medical procedures, so that, in order to prevent this type of contamination, there is a growing demand for solutions in the segment of sanitary metals with a view to block the proliferation of these bacteria.

The great majority of the technologies available in the segment of sanitary metals, for instance, which are based on the application of paints and varnishes additivated with nanoparticles or fungicides. Such solutions have, indeed, an effect, but with the disadvantage of having reduced durability, limited by the resistance of the paint or varnish.

In turn, the use of the nanotechnology for antibacterial action is already known. Among the most widely used materials are Silver and Titanium, which are used since the 18th century in controlling and eliminating bacteria and fungi in hospitals, by virtue of their known antimicrobial characteristics.

Among the examples of this use, one can cite: antimicrobial bandages; biocides for medical and pharmaceutical use; disinfectants and water cleaners; materials for medical use (catheters, cardiac valves, orthopedic implants, etc.; dentistry materials; ceramics and antibacterial thermoplastics; and anti-mold paints and varnishes.

However, one has observed the need to provide antibacterial protection on galvanized materials on the most varied devices or materials, such as sanitary metals (taps, etc.), door-nobs, keys, spoons, forks and knives, pens, shears, glasses, cellular phones, bath room fittings, material and surgical devices, or other metals or manipulated plastics of public or household use, which may be bacterium carriers.

In this regards, the present invention provides a solution in the form of a product containing the technology of the present invention and a process for obtaining surfaces additivated with nanoparticles, which comprises incorporating silver nanoparticles in the galvanic process, thus imparting to the galvanized object efficient antibacterial action and prolonged durability, since they remain linked to the galvanization resistance, which is much greater than the resistance presently imparted by paints and varnishes.

### Objectives of the Invention

The present invention aims at proposing a device and a galvanic process which comprises incorporating silver nanoparticles having antibacterial effect to materials and utensils of the most diverse applications, preventing the application of paints or varnishes to impart such a property.

The galvanic process of the present invention provides metallic or polymeric surfaces additivated with nanoparticles that have an efficient antibacterial action, besides the already known characteristics of the galvanic process itself, such as high resistance to corrosion and to wear, without altering the properties of brightness and cleaning ease.

The use of said metallic surface for application on sanitary products is also described.

### BRIEF DESCRIPTION OF THE INVENTION

The present invention consists of a galvanic process comprising at least one substrate; at least one nickel bath and at least one chrome bath, wherein there is incorporation of silver nanoparticles into at least one nickel bath.

The present invention further consists of a material additivated with silver nanoparticles comprising at least one nickel layer overlapping a substrate and at least one chrome layer overlapping said at least one nickel layer, wherein the thickness of each nickel layer ranges from 5 to 30 μm and at least one nickel layer has dispersed silver nanoparticles and the thickness of the outer chrome layer ranges from 0.2 to μm and 1 μm.

The present invention also consists of the use of a material additivated with silver nanoparticles, obtained by the described process of the present invention, wherein one may apply it to metallic or plastic substrates for antibacterial purposes.

Finally, the present invention consists of a material comprising at least one plastic or metallic substrate, onto which at least one layer of nickel and at least one outer chrome layer are applied, characterized in that the nickel layer comprises silver particles and the chrome layer is permeable to contact with the silver particles present in the nickel layer.

### DESCRIPTION OF THE DRAWINGS

FIG. 1 shows a flowchart indicating one of the possible preferred embodiments of the process of the present invention, comprising the main steps of galvanic deposition bath, wherein the incorporation of nanoparticles may be observed in the phase (10b); and

FIG. 2 shows a material comprising the antibacterial galvanic deposition of the present invention.

### DETAILED DESCRIPTION OF THE INVENTION

The present invention consists of a galvanic process and a product comprising at least one metallic substrate 100 or plastic, onto which one applies at least one bath that results in at least one nickel layer 101 and at least one bath that results in at least one chrome layer 102, the incorporation of silver nanoparticles taking place in at least one nickel bath or layer 101.

By “metallic bath” one understands the galvanic step in which the substrate 100 is fixed to the negative pole of a source of direct current and is then put into a solution ion which there are dispersed metallic ions. Since the substrate 100 plays the role of a cathode, there is deposition of the metal in solution onto the surface thereof, forming a thin metallic layer.

The conventional galvanic process comprises, in a preferably but not compulsory manner, the following 15 steps: chemical degreasing 1; washing in water 2; cathodic electrolytic degreasing 3; anotic electrolytic degreasing 4; washing with water 5; washing with water 6; acidic activation 7; neutral activation 8; washing with water 9; at least one bath in nickel 10a; three-time washing with water 11, 12, 13; bath in chrome solution 14; and washing in water 15, among which said metallic baths correspond to steps 10a and 14.

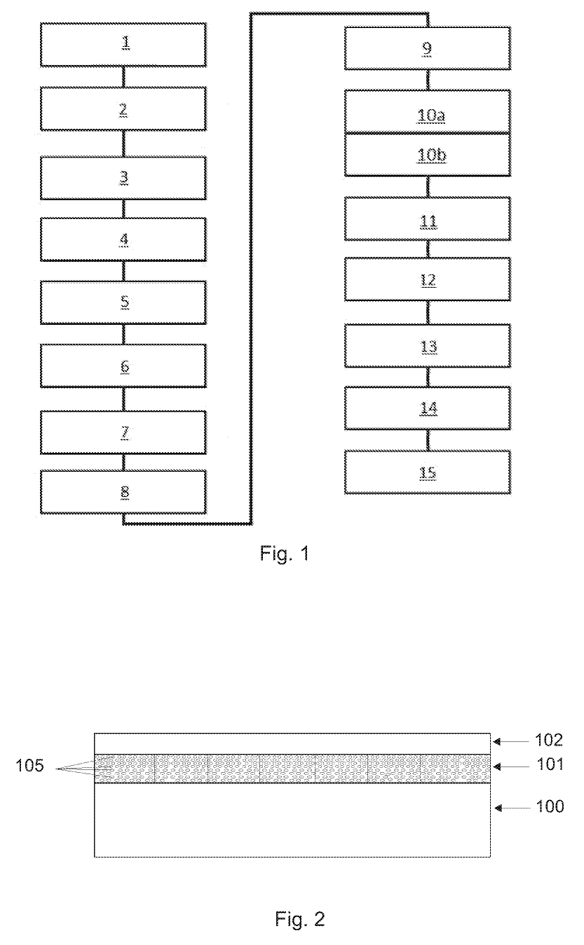

The complete galvanic process of the present invention, that is, the one applied to a material that is additivated with silver nanoparticles comprises the same phases cited above of a conventional galvanic process, with the basic difference that one adds a phase that accounts for the antibacterial action (also usually called antimicrobial or bactericidal action) of the product, as shown in FIG. 1.

More specifically, the complete galvanic process for materials additivated with silver nanoparticles comprises a differentiated additional step ion which at least one nickel bath is additivated with silver nanoparticles 10b.

Thus, the galvanic process of the present invention comprises, in a preferred but not compulsory manner, the steps of: chemical degreasing 1; washing in water 2; cathotic electrolytic degreasing 3; andic electrolytic degreasing 4; washing with water 5; washing with water 6; acidic activation 7; neutral activation 8; washing with water (9); at least one nickel bath 10a; nickel bath additivated with silver nanoparticles 10b; three-time washing with water 11, 12, 13; bath in chrome solution 14; and washing in water 15, thus comprising the metallic bathes 10a, 10b and 14.

In a preferred embodiment of the invention, the additivation with silver nanoparticles takes place in the nickel bath 10b of the nickel layer 101 in contact with the chrome layer 102, that is, in the last nickel layer 101.

It should be noted, in synthesis, that the present invention may further comprise a layer of nickel 101 additivated with silver nanoparticles. Thus, the steps 10a and 10b would be carried out only in a step equivalent to step 10b. Indeed, the various steps for application of the nickel layer 101, for the sake of handling economy, may all be carried out in a nickel bath additivated with silver nanoparticles, that is, the present invention may be achieved with a single step corresponding to step 10b or with a number of repeated steps 10b.

It was observed that the incorporation of silver nanoparticles into the nickel bath 10b provided an antibacterial action that reaches the outer surface of the chromed layer. Thus, the present invention consists of a galvanic process in which there is incorporation of silver nanoparticles into at least one nickel bath, imparting antibacterial properties to the galvanized substrate 100. Naturally the present invention also foresees a material/device with the antibacterial action.

In an embodiment of the invention, the galvanic chroming process of the present invention comprises, in a preferred but not compulsory manner, and therefore not limiting the protection scope of the present invention, the following steps:
(i) subjecting the substrate 100 to one or more nickel baths (10a) after the neutral activation step (8), said nickel bath being composed of: nickel sulfate, nickel chloride, boric acid and commercial brightener additive with current density of 3-6 A/m2 for 9-11 minutes (6-10 Volts), wherein at least one nickel bath is additivated with silver nanoparticles (10b);
(ii) subjecting the substrate 100 obtained in step (1) to chrome solution bath (14) composed chrome salt, sulfuric acid and commercial catalysts, for at least 2 minutes and 15 seconds to at least 4 minutes and 15 seconds, with current density of substantially 0.08-0.32 A/M2 (8-10 Volts), preferably with 0.16 A/m2.

By “substrate 100” one understands the metals selected from: copper and alloys thereof; zinc and alloys thereof; aluminum and alloys thereof; and steel. The substrate 100 may also comprise any type of plastic in which it is possible to have galvanized surface, among them ABS (Acrylinitrile butadiene styrene), Nylon (polyamide) and PBT (Polybutylene Terephthalate), or any other that enables such galvanic deposition or galvanoplasty.

The nanoparticles used in the invention comprise silver oxide in its pure state, nanoparticulated, with particle diameter ranging from 30 to 50 and purity ranging from 95 to 99.9%.

In a preferred category, the purity of the silver oxide is of 99.9%. Thus, the present galvanic chroming process of the present invention imparts to the chromed product/material/device the antibacterial property added to the present-day list of benefits which chroming already provides, among which:

high resistance to corrosion;

high resistance to wear;

extremely smooth and easy to clean; and

color and brightness of great acceptance and value.

In a preferred embodiment of the invention, the galvanic process generates a chromed product of multiple overlapping metallic layers, also object of the present invention, the thickness of at least one or each layer nickel 101 ranging from 5 to 30 μm, wherein at least one of the nickel layers 102 has dispersed silver nanoparticles. The outer chrome layer 102 has minimum thickness of 0.2 μm and may reach maximum thickness of 1 μm.

In a a preferred embodiment of the invention, the minimum thickness of the sum of the nickel layers 101 is of 10 μm.

In another preferred embodiment of the invention, the last nickel layer 101 has dispersed silver nanoparticles.

The present invention can generate a product with one, two, three or more nickel layers 101 and an outer chrome layer 102, wherein at last the last nickel layer 101 comprises dispersed silver particles.

As a more logic option, the silver particles were initially added to the chrome solution that promotes the outer layer 102, but, due to the chemical insolubility of this relation, the silver particles, as time passed, generated a silver decantation reaction in the galvanic bath, impairing the process altogether. Moreover, the addition of the silver particles to the chrome bath 102 did not prove to be interesting, since after some time the silver particles began to destruct the finish of the chrome bath, generating surface roughness and causing rugosity on the finish of the material.

It should be further mentioned that, because of the intrinsic characteristics of the chrome bath, it is not possible prevent the silver particles from sinking due to the agitation of the chrome bath.

Thus, for the case that the silver particles are added to the chrome bath, although the antibacterial efficiency is very good in the beginning of the operation, with the above-mentioned effect of the decantation the antibacterial efficiency is rapidly lost.

The nanoparticles were then added to the nickel bath with additivation range of 2 to 3 ppm, so that the bath will have a prolonged useful life, without the need to correct the mixture and thus achieve the acceptable antibacterial efficiency without making the process too expensive and so as not to impair the chemical solubility of the bath. However, it should be noted that the process results from the capability of keeping the silver nanoparticles in suspension. In a preferred but not compulsory manner, such a solution can be reached by stirring the nickel bath.

Besides solving the question of the process, the stirring of the nickel bath does not impair the bath at all. Naturally, any stirring technique known from the prior art may be applied, without this limiting the protection of the present invention. It should be noted that a possible problem might result from the step of filtering the bath, which, unexpectedly, dos not occur. Thus, the present invention achieves the antibacterial result even for lower concentrations of silver nanoparticles. Thus, in an alternative preferred embodiment, the number of silver nanoparticles may be so small that it will be difficult, is not impossible, with the present-day techniques, to detect the presence thereof in the product when functioning with its antibacterial action.

Anyway, in a preferred embodiment, the additivation is made from 0.005 ppm to 2.6 ppm. It should be noted that any value within this range may be used, but this is no factor limiting the present invention.

Although the outer chrome layer has a small thickness (0.2 to 1 μm), one observes that this layer becomes permeable, and so the antibacterial action is kept, even with the nanoparticles being in a more internal layer.

This occurs because the inner chrome layer is cracked or microcracked. In the bottom, the chrome layer 102 is like a web, that is, it does not exhibit surface continuity, which makes it possible, in the regions of the chrome layer 102 it is interrupted, to keep communication with the nanoparticles that are in a more internal layer, which enables them to develop their antibacterial action. On the other hand, the chrome layer 102 is “permeable” to the action of the silver nanoparticles.

It should be further noted that the titanium, well known for its antibacterial action, may be used in substitution for silver particles. Anyways, one observed that this compound has solubility problems that are not identified in the use of silver according to the above-described process. Even so, even if it does not promote as interesting results as in the case of using silver, it is still possible to obtain a satisfactory solution.

With the present process of the present invention, the silver nanoparticles remain incorporated in the nickel layer 101, imparting antibacterial action for indefinite time, without limitation even to the existence of the chromed layer, since even if the latter wears down, the nickel layer 101 remains on the material on which it has been applied, thus guaranteeing that the silver particles 105, which are included in the nickel layer 101, continue to act.

Thus, the chrome layer 102 is not compulsory for the antibacterial function of the nickel layer 101 with silver particles. This chrome layer 102 has one further esthetic appeal, besides prolonging the durability of the material. However, one notes that the great difficulty encountered until the appearance of the present invention results exactly from the possibility of keeping a chrome layer 102 and the antibacterial function at the same time.

Additionally, this process has the advantage that it can be applied to both metallic substrates 100 and plastic substrates 100, and with the same antibacterial efficiency.

Therefore, the nanoparticulate material obtained by the present process exhibits efficient antibacterial action and can be applied to various materials, such as sanitary metals or bathroom fixtures such as taps, particularly hospital taps, door-nobs, surgical instruments that need constant cleansing. The most interesting thing is that the present invention, being able to be applied to any prior-art object on which nickel baths have already been applied by galvanization, can be object of the antibacterial solution of the present invention.

Thus, the material or product on which the solution of the present invention is applied is not limitative of the protection scope of the present invention. For instance, one may apply a nickel layer 101 with silver particles 105 and an outer chrome layer 102 onto a part such as a door-handle of a vehicle, or onto handrails of subway escalators, or onto products for household or social use.

What matters to understand is that the product will have the following configuration: a plastic or metallic substrate 100, at least one nickel layer 101 comprising silver nanoparticles 105 and at least one outer chrome layer 102, the chrome layer 102 being permeable to the antibacterial action of the silver particles, as explained above.

### EXAMPLE

### Test for Efficacy and Antimicrobial Activity

In order to prove the antibacterial efficacy of the proposed process, two 5×5 cm square brass plates identified as OS 32780/01 free from antibacterial coating and OS 32780/02 having an antibacterial coating with additivation of 2.6 ppm of silver nanoparticles according to the above-described process, were contaminated under equal conditions and concentrations by two species, S. aureus and E. coli.

The plate OS 32780/01, free from antibacterial coating, was subjected to the galvanic process comprising the steps of: chemical degreasing 1; washing in water 2; cathotic electrolytic degreasing 3; andic electrolytic degreasing 4; washing with water 5; washing with water 6; acidic activation 7; neutral activation 8; washing with water (9); two nickel baths 10a; three times washing with water 11, 12, 13; chrome solution bath 14; and washing in water 15, among which said metallic baths correspond to steps 10a and 14.

The plate OS 32780/02, having antibacterial coating with additivation of 2.6 ppm of silver nanoparticles, was subjected to the galvanic process comprising the steps of: chemical degreasing 1; washing in water 2; cathotic electrolytic degreasing 3; andic electrolytic degreasing 4; washing with water 5; washing with water 6; acidic activation 7; neutral activation 8; washing with water (9); one nickel bath 10a; one nickel bath additivated with silver nanoparticles 10b; three times washing with water 11, 12, 13; chrome solution bath 14; and washing in water 15, thus comprising the metallic baths 10a, 10b and 14.

Thus, both plates were coated with two nickel layers and one chrome layer 102.

On plate OS 32780/02 one observes that the additivation with silver nanoparticles took place in the second nickel bath 10b. Thus, although it was not compulsory, with only one option, the nickel layer 101 additivated with silver nanoparticles corresponds to the second nickel layer 101. In these circumstances one uses preferably baths arranged in sequence, wherein the last nickel bath is that which contains the silver nanoparticles 105 (preferably by agitation).

The methodology employed was based on: JIS Z 2801:2000 Japanese Industrial Standard—Antimicrobial product—Test for antimicrobial activity and efficacy.

In order to follow up and quantify the reduction in the number of microorganisms, the counts were made in the time 0 and 24 hours after storage of the parts at room temperature.

The results are shown in the Tables below:

TABLE 1
Results of antibacterial activity for S. aureus.

| | Number of | Number of | | Percentage |
|---|---|---|---|---|
| | bacteria in | bacteria in 24 | Logarythmic | of |
| Sample | time 0 | hours | reduction | reduction |
| OS 32780/01 | 2.7.105 | 2.9.105 | None | |
| OS 32780/02 | 2.7.105 | 7.8.10² | 2.54 | 99.71 |

TABLE 2
Results of antibacterial activity for E. coli.

| | Number of | Number of | | Percentage |
|---|---|---|---|---|
| | bacteria in | bacteria in 24 | Logarythmic | of |
| Sample | time 0 | hours | reduction | reduction |
| OS 32780/01 | 2.5.105 | 3.2.105 | None | |
| OS 32780/02 | 2.5.105 | 1.3.10² | 3.29 | 99.95 |

As can be seen in the above tables, for the two microorganisms used, the sample galvanized by the process of the present invention exhibited potent antibacterial action, with inhibition indexes higher than 99.7% for both cases. However, it should be noted that the present invention is not limited to necessarily so high antibacterial values. It is the application and the type of product that will dictate the need for antibacterial action.

Preferred examples and embodiments having been described, one should understand that the scope of the present invention embraces other possible variations, being limited only by the contents of the accompanying claims, which include the possible equivalents.

1. A galvanic process comprising:
(i) at least one substrate (100);
(ii) at least one nickel bath (10a); and
(iii) at least one chrome bath (14),
characterized in that there is incorporation of silver nanoparticles into at least one nickel bath (10a).

2. The process according to claim 1, characterized ion that the silver nanoparticles comprise silver oxide in their pure state, nanoparticulated, with 95-99.9% purity.

3. The process according to claim 2, characterized in that the silver oxide comprises 99.9% purity.

4. The process according to claim 2, characterized in that the silver oxide has diameter ranging from 30 to 50 nm.

5. The process according to claim 1, characterized in that the silver nanoparticles are added to at least one nickel bath (step (i)) at concentrations of 2 to 3 ppm.

6. The process according to claim 5, characterized in that the silver nanoparticles are added at the concentration of 2.6 ppm.

7. The process according to claim 1, characterized in that the substrate (100) is selected from metals and plastics, comprising:
a) metals: copper and alloys thereof; zinc and alloys thereof; aluminum and alloys thereof; steel;
b) plastics: all those which can have a galvanized surface, among them ABS (Acrylinitrile butadiene styrene), Nylon (polyamide) and PBT (Polybutylene Terephthalate).

8. The process according to claim 1, characterized in that at lest one nickel bath additionally comprises nickel sulfate, nickel chloride, boric acid and commercial brightening additive.

9. The process according to claim 8, characterized in that the nickel bath is carried out for 9 to 11 minutes with current density of 3-6 A/m2 (6-10 Volts).

10. The process according to claim 1, characterized in that the chrome bath (14) additionally comprises a chrome salt, sulfuric acid and commercial catalysts.

11. The process according to claim 10, characterized in that the chrome bath is carried out for 2 minutes and 15 seconds and with current density ranging from 0.08 to 0.32 A/m2.

12. The process according to claim 1, characterized by comprising:
(i) two nickel baths (10a) (10b); and
(ii) one chrome bath (14),
characterized in that the incorporation of silver nanoparticles takes place ion the second nickel batch (10b).

13. A material additivated with silver nanoparticles, characterized by comprising at least one nickel layer (101) overlapping a substrate (100) and at least one chrome layer (102) overlapping at least one nickel layer (101), wherein:
(i) the thickness of each nickel layer (101) ranges from 5 to 30 μm and at lest one nickel layer (101) has dispersed silver nanoparticles; and
(ii) the thickness of the outer chrome layer (102) ranges from 0.2 μm to 1 μm.

14. The material additivated with silver nanoparticles according to claim 13, characterized in that the minimum thickness of the nickel layers (101) is of 10 μm.

15. The material according to claim 13, characterized in that the last nickel layer (101 has dispersed silver nanoparticles (105).

16. Use of a material additivated with silver nanoparticles, obtained by the process as defined in claims 1 to 12 and as defined in claims 13 to 15, characterized by being applied to metallic or plastic substrates (100) for antibacterial purposes.

17. The use of a chromed material additivated with nanoparticles according to claim 16, characterized by being for chroming taps or door-nobs, keys, key-holders, spoons, forks and knives, shears, classes, cellular telephones, vehicle door-handles, handrails, bathroom fixtures, surgical material or other handled metals, for public and household use, which may carry batteries.

18. A material comprising at least one plastic or metallic substrate (100) on which one applies at least one nickel layer (101) and at least one outer chrome layer (102), characterized in that the nickel layer (101) comprises silver particles (105) and the chrome layer (102) is permeable to contact with the silver particles (105) present in the nickel layer (101).
